(19) United States
(12) Patent Application Publication
(10) Pub. No.: US 2020/0198589 A1
(43) Pub. Date: Jun. 25, 2020

(54) WINDSCREEN WIPER DEVICE

(71) Applicant: TRICO BELGIUM SA, Aubange (BE)

(72) Inventor: Eric Fraselle, Hondelange (BE)

(21) Appl. No.: 16/620,737

(22) PCT Filed: Jun. 8, 2017
(86) PCT No.: PCT/EP2017/063976

§ 371 Date: Dec. 9, 2019

(51) Int. Cl. B60S 1/38

(52) U.S. Cl. CPC B60S 1/3887; B60S 2001/3836; B60S 2001/3822

(57) ABSTRACT

A windscreen wiper device of the “flat blade type” is provided comprising an elastic, elongated carrier element and an elongated wiper blade including at least one longitudinal groove, in which groove a longitudinal strip of the carrier element is disposed. The windscreen wiper device comprises a connecting device for an oscillating wiper arm with end caps provided at both free ends of the wiper blade. The end caps each comprise engaging members sidewardly engaging the wiper blade from the outside. The engaging members comprise retaining means that engage into opposing longitudinal slits on said longitudinal sides of said wiper blade to retain the end caps onto the wiper blade. The retaining means comprises at least one sidewardly extending gripping tooth for gripping an intermediate web of the wiper blade. The gripping tooth is hingeable in a longitudinal plane perpendicular to the vertical median plane of the wiper blade.

### BACKGROUND OF THE INVENTION

A windscreen wiper device of the “flat blade type” is generally known. In such a windscreen wiper device of the “flat blade type” no use is made of several yokes pivotally connected to each other, but wherein the wiper blade is biased by the carrier element, as a result of which it exhibits a specific curvature. In practice, the end caps on the one hand and the flexible material of the wiper blade on the other hand need to be interconnected in a durable, solid manner so as to prevent that the end caps may come loose from the wiper blade.

Therefore, there is a need to improve said connection of the end caps on the one hand, but to ensure an easy assembly thereof on the other hand, particularly during the blade assembly process.

### SUMMARY OF THE INVENTION

The object of the invention is to provide an improved windscreen wiper device of the “flat blade type”, wherein no use is made of several yokes pivotally connected to each other, but wherein the wiper blade is biased by the carrier element, as a result of which it exhibits a specific curvature.

The present invention relates to a windscreen wiper device of the “flat blade type” comprising an elastic, elongated carrier element, as well as an elongated wiper blade of a flexible material, which can be placed in abutment with a windscreen to be wiped. The wiper blade includes at least one longitudinal groove, in which groove a longitudinal strip of the carrier element is disposed. The windscreen wiper device comprises a connecting device for an oscillating wiper arm. End caps are provided at both free ends of the wiper blade. The end caps each comprise engaging members sidewardly engaging the wiper blade from the outside. The engaging members comprise retaining means for retaining the end caps onto the wiper blade. The retaining means engage into opposing longitudinal slits on the longitudinal sides of the wiper blade. The retaining means comprises at least one sidewardly extending gripping tooth for gripping an intermediate web of the wiper blade as defined by the opposing longitudinal slits. The engaging members and the retaining means are in one piece. The engaging members and the retaining means are formed by inwardly bent parts of edges of the end cap.

In order to accomplish the stated objective, a windscreen wiper device of the type referred to in the introduction is characterized according to the invention in that the gripping tooth is hingeable in a longitudinal plane perpendicular to the vertical median plane of the wiper blade. The hingeability of the gripping tooth ensures that the grip thereof into the intermediate web of the wiper blade, as defined by the opposing longitudinal slits, is smaller when mounting the end caps onto the wiper blade in a longitudinal direction towards the connecting device than the grip thereof into the intermediate web when dismounting the end caps from the wiper blade in a longitudinal direction away from the connecting device.

It is noted that the present invention is not restricted to cars, but also refers to rail coaches and other (fast) vehicles.

It is noted that the present invention is not restricted to the use of only one longitudinal strip forming the elastic carrier element that is particularly located in a central longitudinal groove of the wiper blade. Instead, the carrier element may also comprise two longitudinal strips, wherein the strips are disposed in opposite longitudinal grooves of the wiper blade. The groove (s) may be closed at one outer end.

Further, it is noted that in the invention use is made of a mounting head fixed for rotation to a shaft. The shaft is rotatable alternately in a clockwise and in a counter-clockwise sense carrying the mounting head into rotation. Thus, in turn the mounting head draws the connecting device into rotation and thereby moves the wiper blade. In the alternative, the mounting head is fixed for translation to a carriage. The carriage can be translated alternately in a one linear direction and in another counter linear direction carrying the mounting head into translation. The present invention can therefore be used for circular or linear movement of the mounting head.

In the framework of the present invention, the following is noted. The connecting device, also called “connector”, is preferably made of plastic. The wiper blade being preferably made of an elastomer material, such as rubber, is particularly made through extrusion. Particularly, the wiper blade comprises a spoiler at a side thereof facing away from the windscreen to be wiped. The wiper blade and the spoiler are preferably made in one piece. The longitudinal groove is preferably a central longitudinal groove accommodating the longitudinal strip. The longitudinal strip is also called a “flexor”. The connecting device is preferably fixedly connected to the longitudinal strip(s) particularly through a welding, brazing (“soldering”), gluing or clamping operation or with the help of a pin inserted through the connecting device and the longitudinal strip(s). In the alternative or in addition thereto, the connecting device is clamped onto the flexible material of the wiper blade, particularly in case the latter is equipped with a central longitudinal groove for the carrier element. Particularly, the connecting device comprises two protuberances extending outwardly on either side thereof.

The protuberances pivotally engage into correspondingly shaped recesses of a joint part interposed between the connecting device and the oscillating arm. The protuberances are preferably cylindrical in shape. All the above preferred features of the present invention can be used alone or in combination with any other feature(s), as a skilled person would appreciate.

In a preferred embodiment of a windscreen wiper device in accordance with the invention, the gripping tooth is hingeable around a restricted neck. Hence, the restricted neck forms a hinge for the gripping tooth and enhances the hingeability thereof, without deteriorating the life span thereof.

In another preferred embodiment of a windscreen wiper device according to the invention, the gripping tooth is bent or biased in a direction away from a free end of the wiper blade.

This ensures that mounting the end caps over the wiper blade does not take a large force, whereas the end caps are retained thereof in a reliable and safe manner.

In another preferred embodiment of a windscreen wiper device in accordance with the invention, the retaining means comprises at least two opposing gripping teeth. The invention ensures that a distance (A) between free tips of said gripping teeth in mounted position of a respective end cap and under the influence of a force in the direction away from a free end of the wiper blade is larger than a distance (B) between free tips of the gripping teeth in mounted position of a respective end cap and under the influence of a force in the direction towards a free end of the wiper blade. Preferably, the end caps each comprise two or three pairs of opposing gripping teeth.

In another preferred embodiment of a windscreen wiper device according to the invention, the wiper blade at both free ends thereof extends beyond said longitudinal strip in order to define at both ends of the wiper blade a space open at one end thereof. The end caps are retained onto the wiper blade so as to dust and water tightly close said groove at both free ends of the wiper blade. The end caps each comprise an interior protrusion fitting inside the space in order to dust and water tightly close said groove at both free ends of the wiper blade. Preferably, the interior protrusion extends longitudinally from an end wall of each end cap.

The present invention also relates to an end cap as a single constructional element arranged to be provided at both free ends of a wiper blade of a windscreen wiper device of the flat blade type. The end cap comprises engaging members arranged to sidewardly engaging the wiper blade from the outside. The engaging members comprise retaining means for retaining the end caps onto the wiper blade. The retaining means are arranged to engage into opposing longitudinal slits on longitudinal sides of the wiper blade. The retaining means comprises at least one sidewardly extending gripping tooth arranged for gripping an intermediate web of the wiper blade as defined by the opposing longitudinal slits. The engaging members and the retaining means are in one piece. The engaging members and the retaining means are formed by inwardly bent parts of edges of the end cap and the gripping tooth is hingeable in a longitudinal plane perpendicular to the vertical median plane of the end cap.

### BRIEF DESCRIPTION OF THE DRAWINGS

The invention will now be explained in more detail with reference to figures illustrated in a drawing, wherein:

FIG. 1 is a perspective, schematic view of a preferred embodiment of a windscreen wiper device according to the invention, together with a detail thereof seen in cross-section;

FIG. 2 is a bottom view of an end cap as used in the windscreen wiper device of FIG. 1; and

FIG. 3 corresponds to FIG. 2 where the end cap is shown in a mounted situation without any force exerted thereon (top) and with a pulling force exerted thereon (below).

### DETAILED DESCRIPTION OF THE PREFERRED EMBODIMENTS

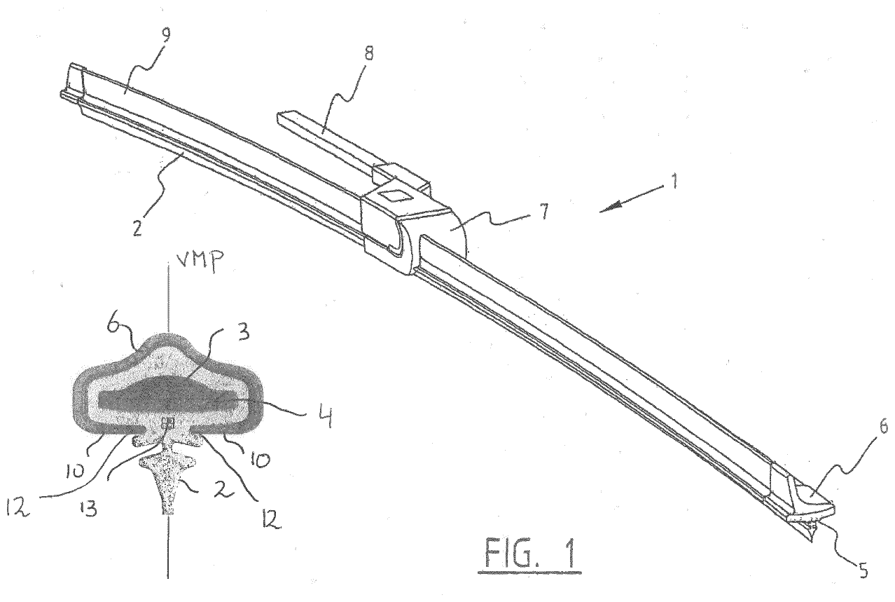

FIG. 1 shows a preferred variant of a windscreen wiper device 1 of the “flat blade type” according to the invention. The windscreen wiper device is built up of an elastomeric wiper blade 2 having a central longitudinal groove 3. A central longitudinal strip 4 made of spring band steel is fitted in the longitudinal groove 3. The strip 4 forms a flexible carrier element for the rubber wiper blade 2, as it were, which is thus biased in a curved position (the curvature in operative position being that of a windscreen to be wiped). At both ends 5 of the wiper blade 2, that is on either side of the windscreen wiper device 1, end caps 6 are provided. The windscreen wiper device 1 is further equipped with a connecting device 7 for an oscillating arm 8 and a spoiler 9. The connecting pieces 6 are both made of one piece of plastic.

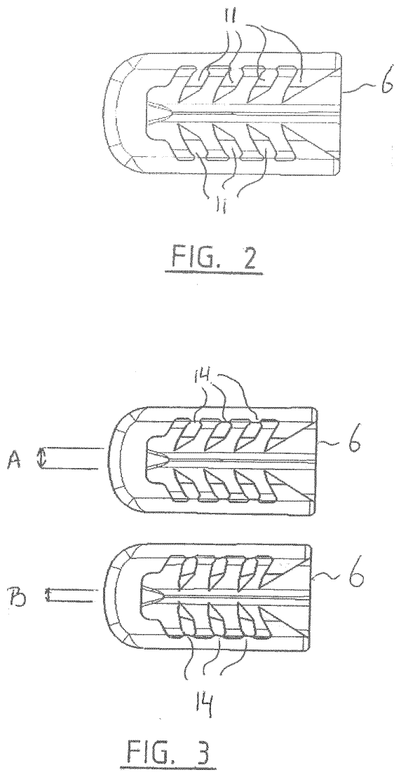

With reference to FIGS. 2 and 3, each connecting piece 6 is provided with two engaging members 10 made integral therewith. The engaging members 10 engage around the wiper blade 2 so as to allow a slidingly mounting of the connecting pieces 6 over the ends 5 of the wiper blade 2. Further, the engaging means 10 include sidewardly extending gripping teeth 11 made integral therewith. The gripping teeth 11 grip inside opposing longitudinal slits 12 and into an intermediate web 13 of the wiper blade 2 (see detail of FIG. 1). Hence, the gripping teeth 11 realize that the connecting pieces 6 are blocked against any movement in longitudinal direction with respect to the wiper blade 2. In case the gripping teeth 11 would be hook-shaped. The hooks are preferably bent or biased in a direction away from the connecting device 7 so that any movement of the wiper blade 2 in a direction towards the connecting piece 6 is blocked by an end wall of the connecting pieces 6, whereas any movement of the wiper blade 2 in a direction away from the connecting pieces 6 is blocked by the hooks. It is noted that the teeth 11 only slightly penetrate the elastomeric (rubber) material of the wiper blade 2 without damaging the same, namely a part of the wiper blade 2 that extends from the strip 4 in a direction towards the windscreen to be wiped.

As a shown in FIGS. 2 and 3, teeth 11 of three opposite teeth pairs are hingeable around a respective restricted neck 14 in a longitudinal plane perpendicular to the vertical median plane (VMP) of the wiper blade 2 (see detail of FIG. 1). The hingeability of the gripping teeth 11 ensures that the grip thereof into the intermediate web 13 of the wiper blade 2, as defined by the opposing longitudinal slits 12, is smaller when mounting the end caps 2 onto the wiper blade 2 in a longitudinal direction towards the connecting device 7 than the grip thereof into the intermediate web 13 when dismounting the end caps 6 from the wiper blade 2 in a longitudinal direction away from the connecting device 7.

The top of FIG. 3 shows a bottom view of the end cap 6 in mounted position on the free end 5 of the wiper blade 2 without any force exerted thereon. Whereas, the bottom of FIG. 3 shows the end cap 6 in the same position but with a pulling force exerted thereon. In general, the distance A between free tips of the gripping teeth 11 in mounted position of a respective end cap 6 and under the influence of a force in the direction away from a free end 5 of the wiper blade 2 is larger than a distance B between free tips of the gripping teeth 11 in mounted position of a respective end cap 6 and under the influence of a force in the direction towards a free end 5 of the wiper blade 2. In case of FIG. 3, A is larger than B.

According to the invention the connecting pieces 6 or end caps are connected to the wiper blade 2 without any connection between the connecting pieces 6 and the strip 4.

The present invention is not limited to the embodiment shown, but extends also to other embodiments falling within the scope of the appended claims.

1. A windscreen wiper device comprising an elastic, elongated carrier element and an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating wiper arm, wherein end caps are provided at both free ends of said wiper blade, said end caps each comprise engaging members sidewardly engaging said wiper blade from the outside, wherein said engaging members comprise retaining means for retaining said end caps onto said wiper blade, wherein said retaining means engage into opposing longitudinal slits on longitudinal sides of said wiper blade, wherein said retaining means comprises at least one sidewardly extending gripping tooth for gripping an intermediate web of said wiper blade as defined by said opposing longitudinal slits, wherein said engaging members and said retaining means are in one piece, and wherein said engaging members and said retaining means are formed by inwardly bent parts of edges of said end cap, wherein said gripping tooth is hingeable in a longitudinal plane perpendicular to the vertical median plane of the wiper blade.

2. The windscreen wiper device according to claim 1, wherein said gripping tooth is hingeable around a restricted neck.

3. The windscreen wiper device according to claim 1, wherein said gripping tooth is bent in a direction away from a free end of said wiper blade.

4. The windscreen wiper device according to claim 1, wherein said retaining means comprises at least two opposing gripping teeth.

5. The windscreen wiper device according to claim 4, wherein a distance (A) between free tips of said gripping teeth in mounted position of a respective end cap and under the influence of a force in the direction of the connector of said wiper blade is larger than a distance (B) between free tips of said gripping teeth in mounted position of a respective end cap and under the influence of a force in the direction opposite to the connector of said wiper blade.

6. The windscreen wiper device according to claim 1, wherein said wiper blade at both free ends thereof extends beyond said longitudinal strip in order to define at both ends of said wiper blade a space open at one end thereof, wherein said end caps are retained onto said wiper blade so as to dust and water tightly close said groove (3) at both free ends (5) of said wiper blade (2), and wherein said end caps (6) each comprise an interior protrusion fitting inside said space in order to dust and water tightly close said groove (3) at both free ends (5) of said wiper blade (2).

7. The windscreen wiper device according to claim 6, wherein said interior protrusion extends longitudinally from an end wall of each end cap.
